(19) United States
(12) Patent Application Publication
(10) Pub. No.: US 2013/0224566 A1
(43) Pub. Date: Aug. 29, 2013

(54) MOLTEN-SALT BATTERY AND MOLTEN-SALT BATTERY CONNECTED BODY

(71) Applicants: Shoichiro Sakai, Osaka-shi, Osaka (JP); Atsushi Fukunaga, Osaka-shi, Osaka (JP); Koji Nitta, Osaka-shi, Osaka (JP); Masatoshi Majima, Osaka-shi, Osaka (JP); Shinji Inazawa, Osaka-shi, Osaka (JP)

(72) Inventors: Shoichiro Sakai, Osaka-shi, Osaka (JP); Atsushi Fukunaga, Osaka-shi, Osaka (JP); Koji Nitta, Osaka-shi, Osaka (JP); Masatoshi Majima, Osaka-shi, Osaka (JP); Shinji Inazawa, Osaka-shi, Osaka (JP)

(73) Assignee: SUMITOMO ELECTRIC INDUSTRIES, LTD, Osaka-shi, Osaka (JP)

(21) Appl. No.: 13/879,560

(22) PCT Filed: Oct. 17, 2011
(86) PCT No.: PCT/JP2011/073870

§ 371 Date: Apr. 15, 2013

(30) Foreign Application Priority Data
Oct. 18, 2010 (JP) 2010-233951

(51) Int. Cl. H01M 2/04

(52) U.S. Cl. CPC H01M 2/04
USPC 429/158; 429/163

(57) ABSTRACT

This molten-salt battery is provided with a battery container for housing a power generation element that contains molten salt. The battery container is provided with a container body (1) and a lid (7). An opening (1E) is provided in the upper surface of the container body (1). The lid (7) is fitted in the opening (1E) of the container body (1) and is welded to the container body (1). A step (1G) is formed to the opening (1E) of the container body (1) along the inner edge of the container body (1). By means of the step (1G), the rim (7A) of the lid (7) is supported with respect to the upper corner of side walls (1A, 1B). Laser light is radiated from above to the rim (7A) of the lid (7) and the upper surface of the side walls (1A, 1B) adjacent thereto. In this way, the rim (7A) of the lid (7) is welded to the container body (1). The molten-salt battery connected body is configured from a plurality of molten-salt batteries. The molten-salt batteries are connected aligned in the horizontal direction in the state of the outer peripheral surfaces of the container bodies (1) of adjacent molten-salt batteries being caused to face each other.

### FIELD OF THE INVENTION

The present invention relates to a molten-salt battery and a molten-salt battery module including a combination of such molten-salt batteries.

### BACKGROUND OF THE INVENTION

Power generation by solar power, wind power, and other natural energy resources, which emits no carbon dioxide, has recently been promoted. However, the amount of power generation by natural energy is subject to natural conditions such as climate and weather. In addition, since it is difficult to adjust the amount of power generation to meet demand, electric-load leveling is needed. Thus leveling generated electric energy through charging and discharging requires a high-energy-density, high-efficiency, and high-capacity storage battery. Molten-salt batteries, which use a molten salt electrolyte to meet such requirements, have been attracting attention.

Molten-salt batteries include an electric generation element composed of a positive electrode, a negative electrode, and a separator arranged between the positive electrode and the negative electrode. The positive electrode is composed of a current collector containing an active material of sodium compound. The negative electrode is composed of a current collector plated with metal such as tin. The separator is impregnated with a molten salt composed of an alkali metal cation, such as sodium or potassium, and an anion containing fluorine. The electric generation element is housed in a battery container. It is often the case that molten-salt batteries are formed of a combination of multiple cells to achieve a higher capacity.

Conventional battery containers include a box-like container body and a lid. An opening is formed at the top of the container body. The opening of the container body is closed by the lid. For example, Patent Document 1 discloses a molten-salt battery that includes a container body having an opening at the top thereof and a cap-like lid having an upper wall and a peripheral wall. The lid is fitted from above to the container body in such a manner as to close the opening. Patent Document 2 discloses a secondary battery, though not a molten-salt battery. The secondary battery includes a cylindrical cap-like lid and a cylindrical container body. The lid is fitted by pressure bonding to the container body in such a manner as to close the opening.

As for such conventional battery containers as mentioned above, for example, a laser is used to weld a rim portion of the lid to the container body and thereby to seal the container body with the lid. In this case, a laser beam is applied from the side to the outer peripheral surface of the container body. There is also a case that multiple container bodies are arranged laterally to form and use a combination of multiple cells. In this case, an electric generation element is housed in and then a lid is fitted to each of the multiple container bodies. In such a case, however, it is difficult to apply a laser beam from the side to the outer peripheral surface of each container body due to obstruction by the adjacent container body.

### PRIOR ART DOCUMENT

### Patent Document

Patent Document 1: Japanese Laid-Open Patent Publication No. 07-22066

Patent Document 2: Japanese Laid-Open Patent Publication No. 2009-93983

### SUMMARY OF THE INVENTION

It is hence an objective of the present invention to provide a molten-salt battery having a structure whereby a laser beam or the like can be applied from above to a container body to weld a rim portion of a lid to the container body, and also a molten-salt battery module including a combination of such molten-salt batteries.

To achieve the foregoing objective and in accordance with a first aspect of the present invention, a molten-salt battery including a battery container that houses an electric generation element containing a molten salt is provided. The battery container includes a container body having an opening at the top thereof and a lid having a rim portion. The rim portion of the lid is fitted in the opening and welded to the container body.

In accordance with the arrangement above, the lid is fitted in the opening at the top of the container body. A laser beam is then applied from above to the rim portion of the lid and the top of the container body adjacent to the rim portion. The rim portion of the lid is thus welded to the container body, so that the electric generation element containing the molten salt is sealed in the battery container.

In the above described molten-salt battery, the opening of the container body is formed with a stepped portion along the inner peripheral edge of the container body, and the rim portion of the lid is supported by the stepped portion.

In accordance with the arrangement above, the rim portion of the lid is fitted in the opening of the container body. In this case, the lid is supported by the stepped portion formed in the opening of the container body. The lid can thus be fitted stably in the opening of the container body. In this state, a laser beam can then be applied from above to weld the rim portion of the lid to the container body.

In the above described molten-salt battery, the opening of the container body is formed with a protrusion along the inner peripheral edge of the container body, and the rim portion of the lid is supported by the protrusion.

In accordance with the arrangement above, the rim portion of the lid is fitted in the opening of the container body. In this case, the lid is supported by the protrusion formed in the opening of the container body. The lid can thus be fitted stably in the opening of the container body. In this state, a laser beam can then be applied from above to weld the rim portion of the lid to the container body.

To achieve the foregoing objective and in accordance with a second aspect of the present invention, a molten-salt battery including a battery container that houses an electric generation element containing a molten salt is provided. The battery container includes a container body having an opening at the top thereof and a lid having a rim portion, and the rim portion of the lid is placed on an opening edge portion of the container body and welded to the container body.

In accordance with the arrangement above, the rim portion of the lid is placed on the opening edge portion of the container body. A laser beam is then applied from above to the rim portion of the lid and the opening edge portion of the container body adjacent to the rim portion. The rim portion of the lid is thus welded to the container body, so that the electric generation element containing the molten salt is sealed in the battery container.

In the above described molten-salt battery, a stepped portion to be engaged with the corner of the opening edge portion of the container body is formed in a lower part of the rim portion of the lid.

In accordance with the arrangement above, the rim portion of the lid is placed on the opening edge portion of the container body. In this case, the stepped portion formed on the lid is engaged with the corner of the opening edge portion of the container body. This allows the rim portion of the lid to be held such that the lid does not separate from the opening edge portion of the container body. The rim portion of the lid can thus be placed stably on the opening edge portion of the container body. In this state, a laser beam can then be applied from above to weld the rim portion of the lid to the container body.

In the above described molten-salt battery, a protrusion to be engaged with the corner of the opening edge portion of the container body is formed on the lower surface of the rim portion of the lid.

In accordance with the arrangement above, the rim portion of the lid is placed on the opening edge portion of the container body. In this case, the protrusion formed on the lid is engaged with the corner of the opening edge portion of the container body. This allows the rim portion of the lid to be held such that the lid does not separate from the opening edge portion of the container body. The rim portion of the lid can thus be placed stably on the opening edge portion of the container body. In this state, a laser beam or the like can then be applied from above to weld the rim portion of the lid to the container body.

In the above described molten-salt battery, the electric generation element includes plate-like positive and negative electrodes and a separator arranged between the positive and negative electrodes and containing the molten salt. Also, the positive and negative electrodes are arranged in a manner facing each other with the side surfaces thereof being oriented vertically.

In accordance with the arrangement above, the electric generation element can be housed from above into the container body, and thereafter the battery container can be closed by welding the lid to the container body.

To achieve the foregoing objective and in accordance with a third aspect of the present invention, a molten-salt battery module including a plurality of molten-salt batteries described above is provided. The molten-salt batteries are arranged and connected laterally with the outer peripheral surfaces of the container bodies of adjacent molten-salt batteries facing each other.

In accordance with the arrangement above, multiple molten-salt batteries are arranged with the outer peripheral surfaces of the container bodies of adjacent molten-salt batteries facing each other. An electric generation element is housed into each container body of the thus arranged molten-salt batteries. Next, adjacent molten-salt batteries are connected together. A laser beam is then applied from above to weld a lid to each container body so that the electric generation element is sealed in each battery container.

In accordance with the present invention, a molten-salt battery is provided that has a structure in which a laser beam or the like can be applied from above to a container body to weld a rim portion of a lid to the container body. In conventional processes of manufacturing a molten-salt battery module, multiple molten-salt batteries have been arranged laterally, which may cause a narrow gap between the container bodies of adjacent molten-salt batteries. Compared to this, in accordance with the present invention, a laser beam or the like can be applied from above to each molten-salt battery to weld the rim portion of the lid to the container body. This eliminates the necessity for an excess installation space.

### BRIEF DESCRIPTION OF THE DRAWINGS

FIG. 1 is a perspective view of a molten-salt battery according to a first embodiment of the present invention;

FIG. 2 is a horizontal cross-sectional view of an electric generation element;

FIG. 3(a) is a top view of the molten-salt battery;

FIG. 3(b) is a vertical cross-sectional view of the molten-salt battery;

FIG. 4(a) is a plan view of a lid;

FIG. 4(b) is a vertical cross-sectional view of the lid;

FIG. 5(a) is a cross-sectional view showing a structure whereby the lid is fitted to a container body;

FIG. 5(b) is a cross-sectional view showing a fitting structure of a lid according to a comparative example;

FIG. 6 is a vertical cross-sectional view of a molten-salt battery module including a combination of multiple molten-salt batteries;

FIG. 7 is a partially enlarged cross-sectional view of a connection of the molten-salt battery module;

FIG. 8(a) is a plan view of a container body of a molten-salt battery according to a second embodiment of the present invention;

FIG. 8(b) is a partially vertical cross-sectional view of the container body;

FIG. 9(a) is a plan view of a container body of a molten-salt battery according to a third embodiment of the present invention;

FIG. 9(b) is a partially vertical cross-sectional view of the container body;

FIG. 10(a) is a plan view of a container body of a molten-salt battery according to a fourth embodiment of the present invention;

FIG. 10(b) is a partially vertical cross-sectional view of the container body;

FIG. 11(a) is a top view of a molten-salt battery according to a fifth embodiment of the present invention;

FIG. 11(b) is a vertical cross-sectional view of the molten-salt battery;

FIG. 12(a) is a plan view of a lid of the molten-salt battery;

FIG. 12(b) is a vertical cross-sectional view of the lid;

FIG. 13 is a partially enlarged cross-sectional view of a connection of a molten-salt battery module;

FIG. 14(a) is a plan view of a lid of a molten-salt battery according to a sixth embodiment of the present invention;

FIG. 14(b) is a vertical cross-sectional view of the lid; and

FIG. 15 is a partially enlarged cross-sectional view of a connection of a molten-salt battery module.

### DETAILED DESCRIPTION OF THE PREFERRED EMBODIMENTS

### First Embodiment

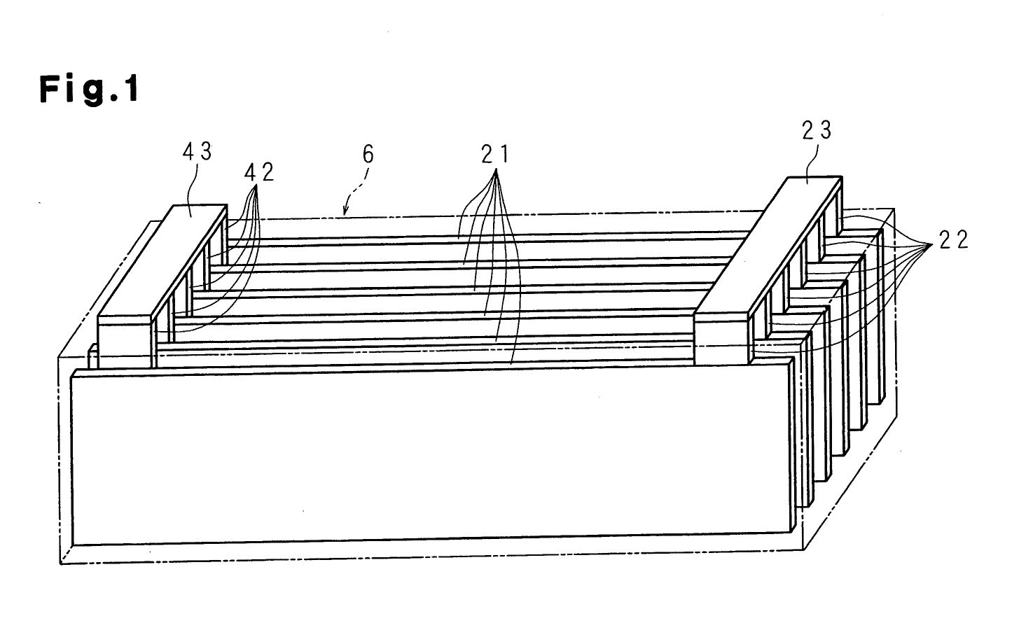

A molten-salt battery and a molten-salt battery module according to a first embodiment of the present invention will hereinafter be described in detail with reference to FIGS. 1 to 7.

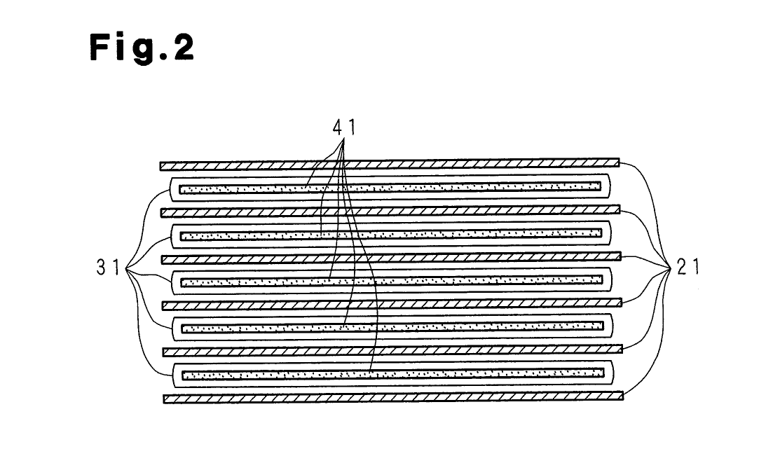

As shown in FIGS. 1 and 2, the molten-salt battery includes six rectangular plate-like negative electrodes 21 and five rectangular plate-like positive electrodes 41. The positive electrodes 41 are each housed in a bag-like separator 31. The negative electrodes 21 and the positive electrodes 41 are arranged with the side surfaces thereof being oriented vertically. The negative electrodes 21 and the positive electrodes 41 are also arranged laterally and alternately in a manner facing each other. One negative electrode 21, one separator 31, and one positive electrode 41 constitute one electric generation element. In the first embodiment, five electric generation elements are stacked and housed in a battery container 10.

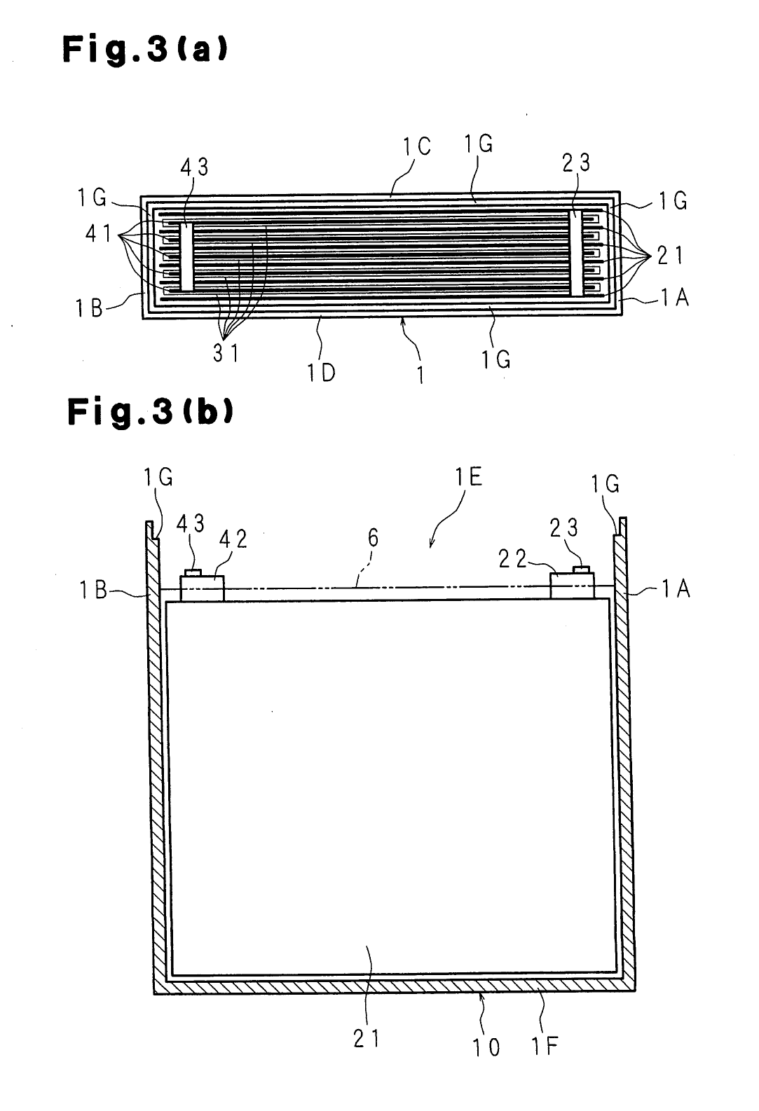

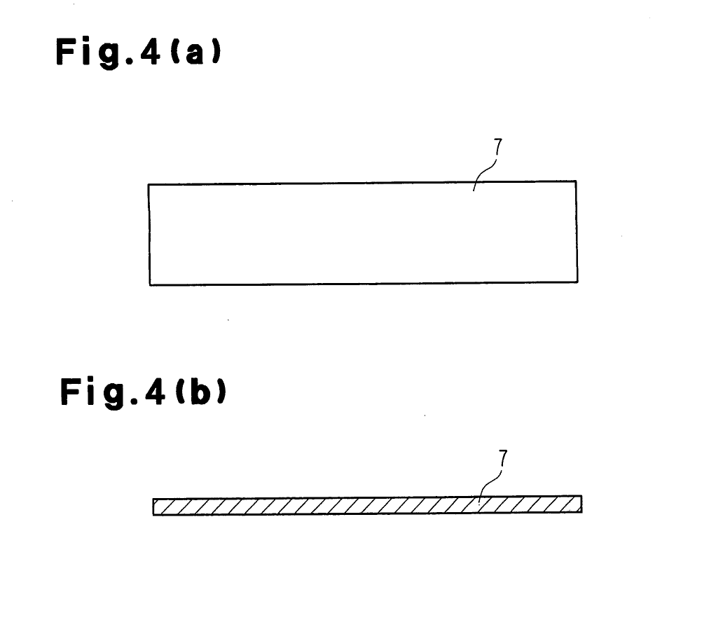

As shown in FIGS. 3(a) to 4(b), the battery container 10 is formed in a rectangular parallelepiped shape. The battery container 10 has a container body 1 and a lid 7. An opening 1E is provided at the top of the container body 1. The lid 7 is fitted in the opening 1E of the container body 1 to close the opening 1E. The container body 1 includes side walls 1A, 1B, 1C, and 1D, and a bottom wall 1F. In a plan view, the side walls 1A and 1B are arranged along the respective short sides of the container body 1, while the side walls 1C and 1D are arranged along the respective long sides of the container body 1. The container body 1 is made of aluminum alloy. The interior surface of the container body 1 is insulated with fluorine coating.

A lower end portion of a rectangular tab (conductor) 22 for collecting current is joined to an upper end portion of each negative electrode 21. The tab 22 is located in the vicinity of the side wall 1A. An upper end portion of the tab 22 is bonded to the lower surface of a rectangular plate-like tab lead 23. A lower end portion of a rectangular tab 42 for collecting current is joined to an upper end portion of each positive electrode 41. The tab 42 is located in the vicinity of the side wall 1B. An upper end portion of the tab 42 is joined to the lower surface of a rectangular plate-like tab lead 43. The five electric generation elements are thus connected electrically in parallel to form a high-capacity molten-salt battery.

Each one of the negative electrodes 21 is composed of an alloy plate formed by plating aluminum with tin serving as a negative-electrode active material. Aluminum is suitably used for positive- and negative-electrode current collectors. Aluminum has corrosion resistance to molten salts. The negative electrode 21 containing the active material has a thickness of about 0.14 mm. The negative electrode 21 also has a height of 100 mm and a width of 120 mm. Each one of the positive electrodes 41 is formed by filling an aluminum alloy porous solid with a mixture of binder, conductive additive, and NaCrO₂ serving as a positive-electrode active material. The positive electrode 41 has a thickness of about 1 mm. The height and width of the negative electrode 21 is about 1.2 times larger than those of the positive electrode 41. The outer edge of the positive electrode 41 is opposed to the peripheral edge portion of the negative electrode 21 via a separator 31. The scale factor of the negative electrode 21 to the positive electrode 41 is not limited to 1.2 times.

Each one of the separators 31 is composed of a porous material and formed in a bag-like shape. Specifically, the separator 31 is composed of a fluorine resin film having resistance to a molten salt 6 at the temperature at which the molten-salt battery operates. The separator 31 is immersed in the molten salt 6 in the battery container 10 to a depth of about 10 mm below the liquid level together with the negative electrode 21 and the positive electrode 41. This allows some lowering of the liquid level. The tab leads 23 and 43 serve as external electrodes providing connection between all of the stacked electric generation elements and an external electric circuit. The tab leads 23 and 43 are located above the liquid level of the molten salt 6. The molten salt 6 is composed of an FSI (bis-fluorosulfonyl-imide) or TFSI (bis-trifluorosulfonyl-imide) anion and a sodium and/or potassium cation, but not limited thereto.

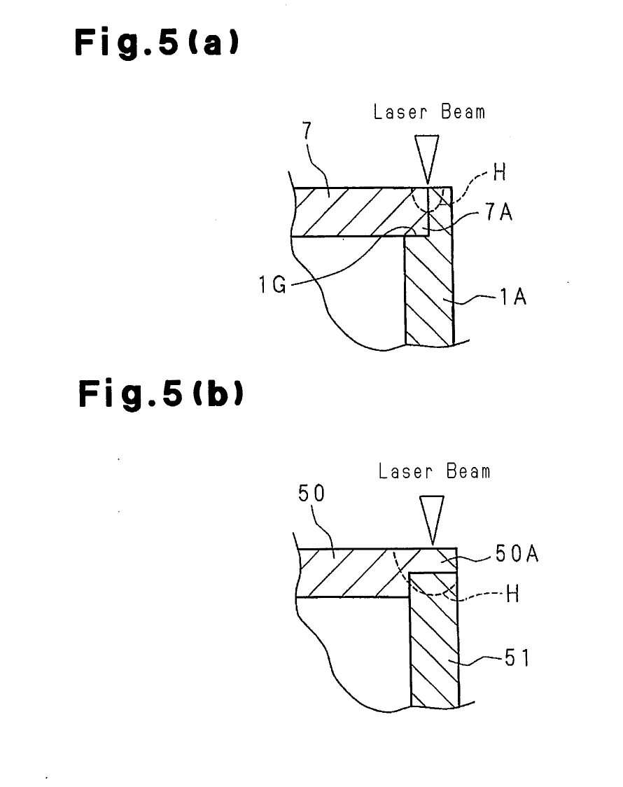

On the inner sides of upper end portions of the side walls 1A, 1B, 1C, and 1D, a stepped portion 1G is formed all around the opening 1E of the battery container 10. The vertical dimension of the stepped portion 1G is set equal to the thickness of the lid 7. The lid 7 is a rectangular parallelepiped plate. In a plan view, the outside dimension of the lid 7 is set substantially equal to or slightly smaller than the inside dimension of the stepped portion 1G. This causes the lid 7 to be placed down on the stepped portion 1G and fitted in the opening 1E of the container body 1 as shown in FIGS. 5(a) and 5(b). In this state, a laser beam is applied from above to a rim portion 7A of the lid 7 and the upper end portions of the side walls 1A, 1B, 1C, and 1D of the container body 1 adjacent to the rim portion 7A. The rim portion 7A of the lid 7 is thus welded to the container body 1. In this case, it is preferable to spot-weld different portions on the periphery of the lid 7 for a temporary joint, and thereafter to weld the remaining portions.

The first embodiment, which has heretofore been described in detail, exhibits the following advantages.

(1) FIG. 5(b) shows a case where a lid 50 is placed on the entire upper end of a side wall 51 of a container body. In this case, welding through application of a laser beam on the upper surface of the lid 50 requires that thermal energy reach the upper part of the side wall 51. Accordingly, in addition to higher welding energy, there is a high possibility of poor welding due to expansion of the range H of melting. Compared to this, in accordance with the first embodiment, the lid 7 is fitted in the opening 1E of the container body 1 as shown in FIG. 5(a). A laser beam is then applied from above to the rim portion 7A of the lid 7 and the upper end portions of the side walls 1A, 1B, 1C, and 1D next to the rim portion 7A. In this case, the range H of melting by the laser beam can be reduced, whereby the lid 7 can be welded reliably to the container body 1 even with lower energy. In addition, the generation of spatter, that is, metal particles scattering during welding is suppressed, whereby mixing of spatter into the container body 1 resulting in a short-circuiting is prevented.

In the arrangement above, heating the entire battery container 10 to 85° C. to 95° C. with external heating means (not shown) allows the molten salt 6 to be melted for charging and discharging.

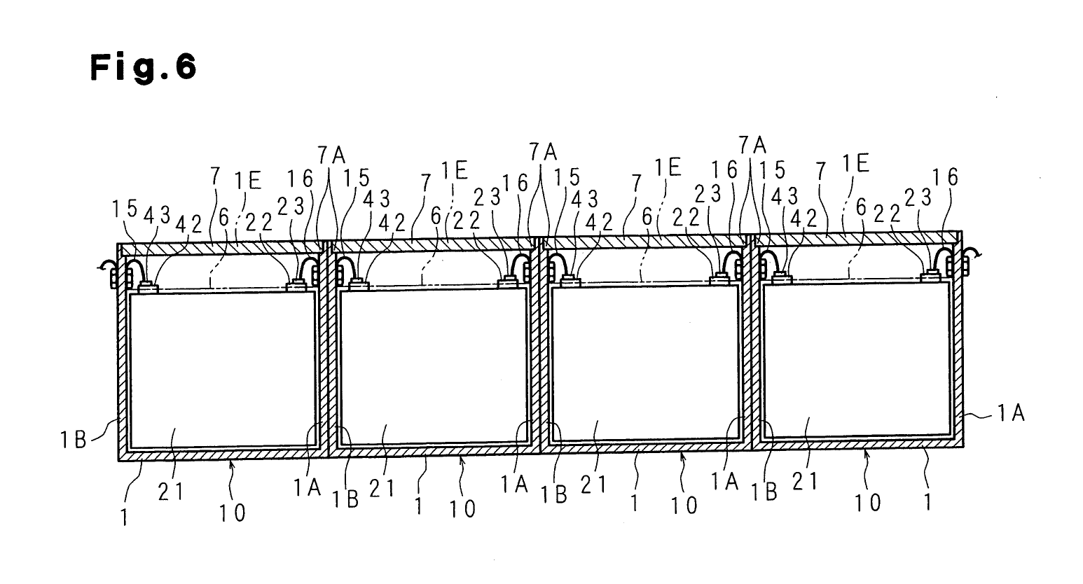

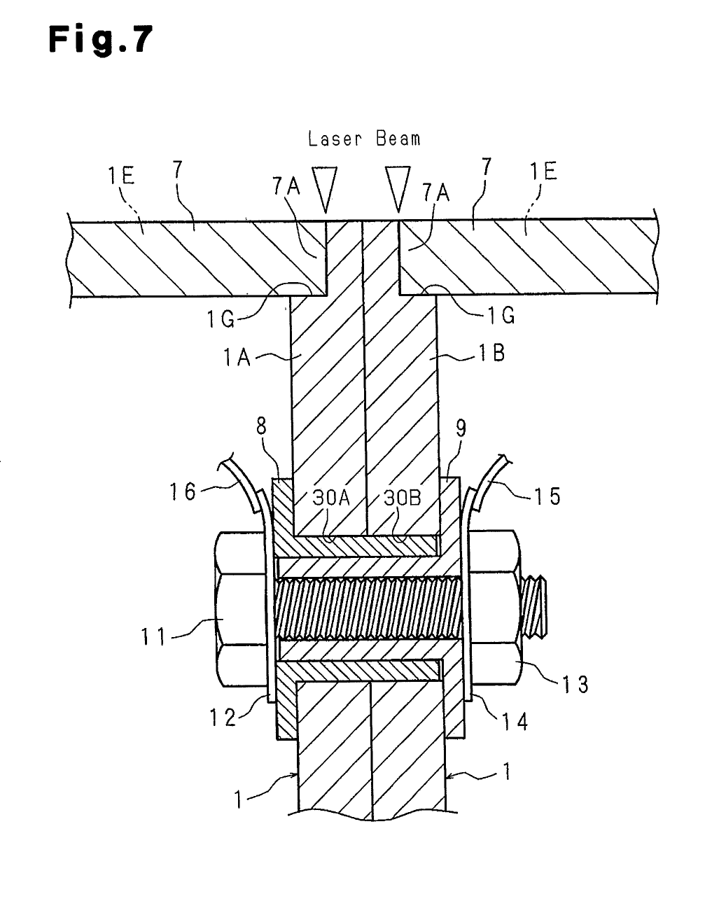

Next will be described with reference to FIGS. 6 and 7 a molten-salt battery module (molten-salt assembled battery), in which multiple molten-salt batteries are connected in series to achieve a higher battery voltage.

As shown in FIG. 6, the molten-salt battery module is formed by connecting four molten-salt batteries. Before the lids 7 are mounted, the four container bodies 1 are arranged such that the side walls 1A and 1B of adjacent container bodies 1 are placed right next to each other. In each of the container bodies 1, an electric generation element, that is, a negative electrode 21, a separator 31, a positive electrode 41, and a molten salt 6 are housed.

As shown in FIG. 7, laterally extending through holes 30A and 30B are provided in upper end portions of the side walls 1A and 1B placed right next to each other. An insulating bushing (bearing cylinder) 8 made of Teflon (registered trademark) is fitted into the through holes 30A and 30B from the side wall 1A. On the other hand, another bushing 9 made of Teflon is fitted into the through holes 30A and 30B from the side wall 1B. The outside diameter of the bushing 9 is substantially equal to the inside diameter of the bushing 8. An aluminum-alloy bolt 11 is inserted via a metal washer 12 through the bushing 9 from the side wall 1A. The outside diameter of the bolt 11 is substantially equal to the inside diameter of the bushing 9. The leading end of the bolt 11 protrudes from the side wall 1B into the container body 1. An aluminum-alloy nut 13 is threaded via a metal washer 14 on the leading end of the bolt 11.

With the arrangement above, the side walls 1A and 1B are fastened to each other with the bolt 11 and the nut 13 via the insulating bushings 8 and 9. The washers 12 and 14 are connected electrically to each other via the bolt 11, while insulated electrically from the side walls 1A and 1B.

An aluminum-alloy lead wire 16 is joined to the washer 12 in the vicinity of the side wall 1A. On the other hand, an aluminum-alloy lead wire 15 is joined to the washer 14 in the vicinity of the side wall 1B. The lead wire 16 is joined to the tab lead 23, while the lead wire 15 is joined to the tab lead 43. This causes the tab lead 23 in the vicinity of the side wall 1A and the tab lead 43 in the vicinity of the side wall 1B, which faces the side wall 1A, to be connected electrically, and thereby connecting the adjacent molten-salt batteries in series. Thereafter, the lids 7 are fitted in the openings 1E of the respective container bodies 1 and a laser beam is applied from above. The rim portions 7A of the lids 7 are thus welded to the respective container bodies 1.

### Second Embodiment

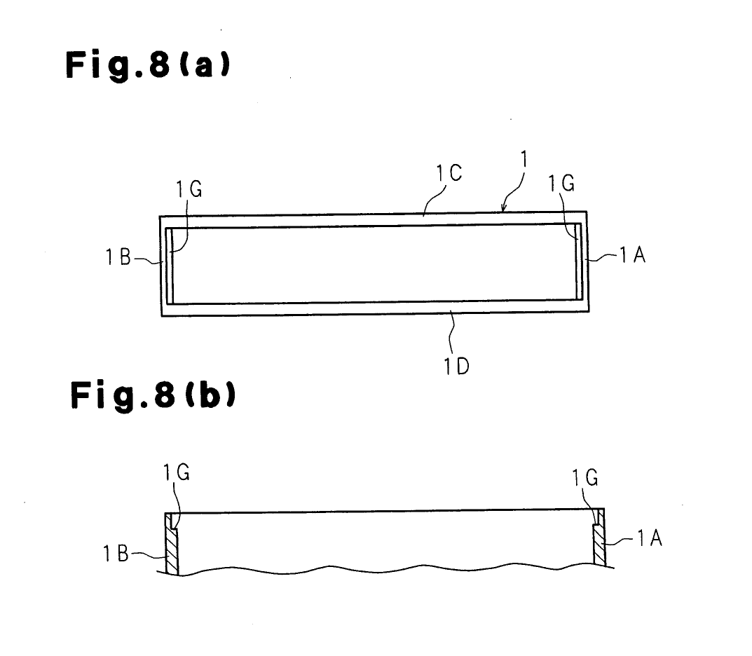

A second embodiment of the present invention will hereinafter be described with reference to FIGS. 8(a) and 8(b). Components in the second embodiment identical to those in the first embodiment will not be described in detail.

The second embodiment is different from the first embodiment in that the stepped portion 1G is formed not on the side walls 1C and 1D but only in the upper end portions of the side walls 1A and 1B. In a plan view, the outside dimension of the lid 7 along the short sides in the second embodiment is smaller than that in the first embodiment by substantially twice the width of the stepped portion 1G.

### Third Embodiment

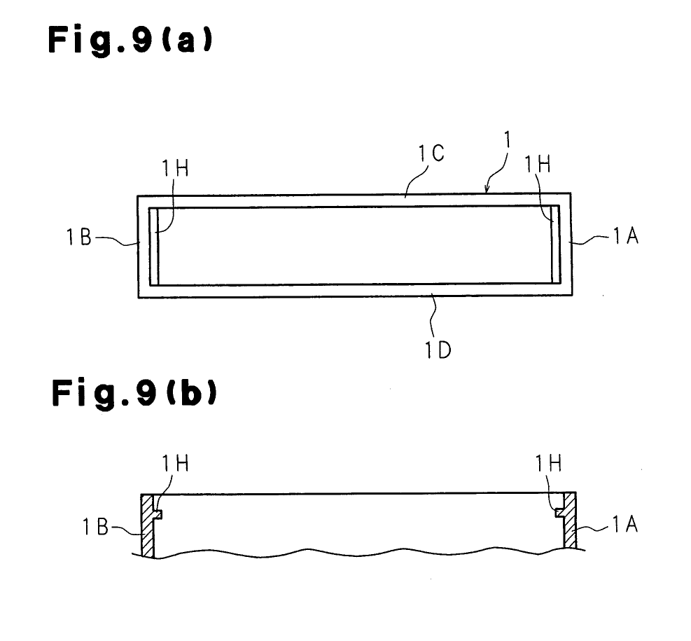

A third embodiment of the present invention will hereinafter be described with reference to FIGS. 9(a) and 9(b). Components in the third embodiment identical to those in the first embodiment will not be described in detail.

The third embodiment is different from the first embodiment in that no stepped portion 1G is formed in the upper end portions of the side walls 1A, 1B, 1C, and 1D, but a protrusion 1H is provided on the interior surface of each side wall. As shown in FIGS. 9(a) and 9(b), band-like protrusions 1H are provided on the side walls 1A and 1B. The length of the protrusions 1H is equal to the distance between the side walls 1C and 1D. In a plan view, the outside dimension of the lid 7 along the long sides in the third embodiment is smaller than that in the second embodiment by substantially twice the width of the stepped portion 1G.

### Fourth Embodiment

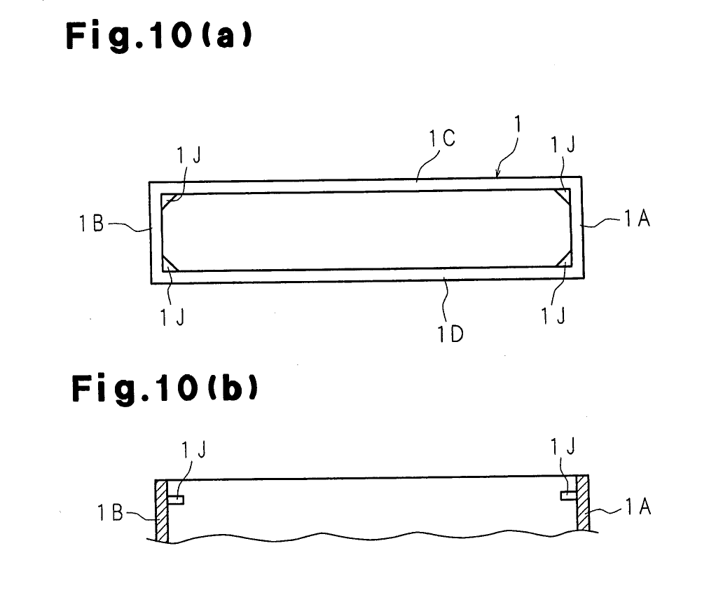

A fourth embodiment of the present invention will hereinafter be described with reference to FIGS. 10(a) and 10(b). Components in the fourth embodiment identical to those in the first embodiment will not be described in detail.

The fourth embodiment is different from the third embodiment in that protrusions 1J are provided at the four corners of the container body 1. In a plan view, the outside dimension of the lid 7 in the fourth embodiment is equal to that in the third embodiment.

In the first embodiment, the upper surface of the lid 7 is flush with the upper ends of the side walls 1A, 1B, 1C, and 1D in the state where the lid 7 is welded to the container body 1. However, the thickness of the lid 7 may be different from the vertical dimension of the stepped portion 1G so that the upper surface of the lid 7 is not flush with the upper ends of the side walls 1A, 1B, 1C, and 1D.

### Fifth Embodiment

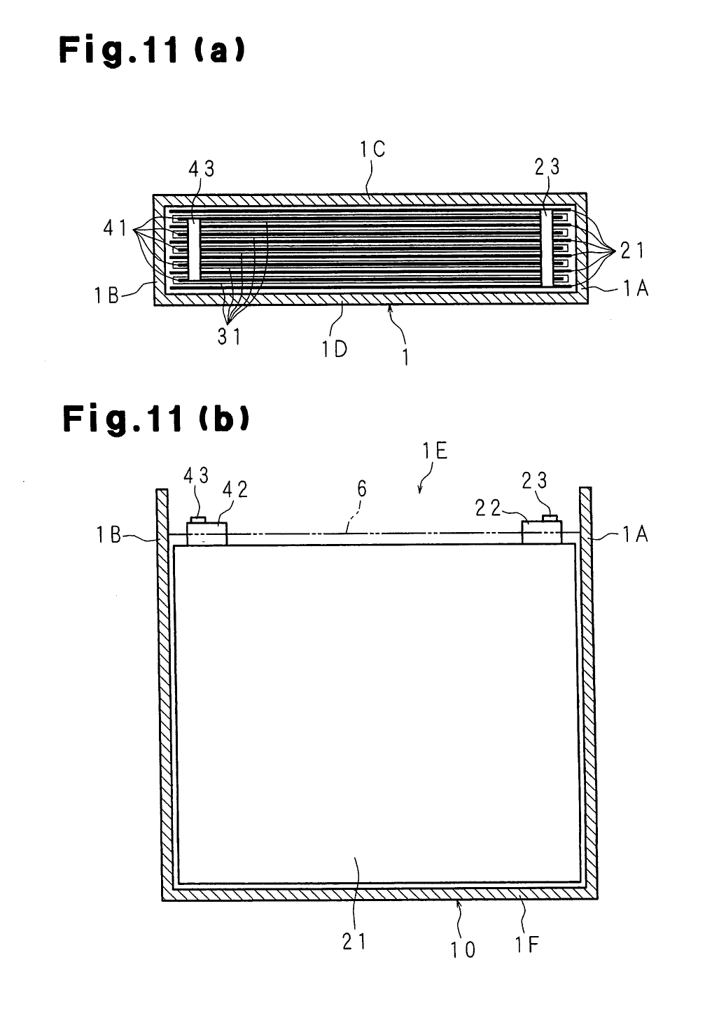

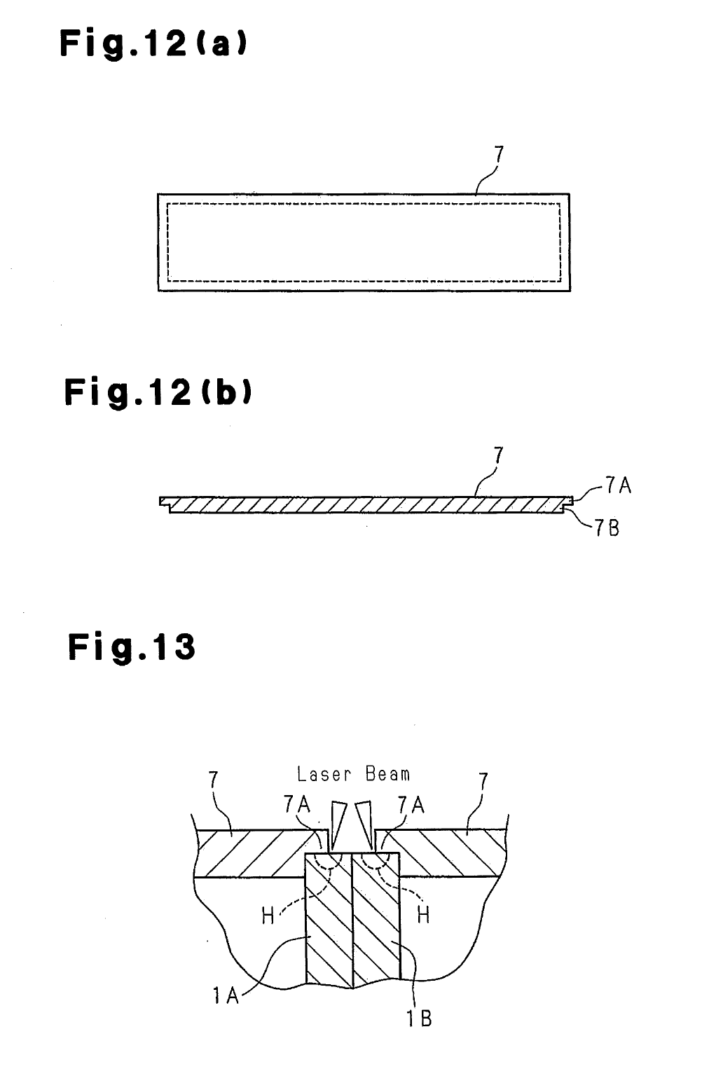

A fifth embodiment of the present invention will hereinafter be described with reference to FIGS. 11(a) to 13. Components in the fifth embodiment identical to those in the first embodiment will not be described in detail.

In the first embodiment, the lid 7 is fitted in the opening 1E of the container body 1. The fifth embodiment is different from the first to fourth embodiments in that a stepped portion 7B is formed in a lower part of the rim portion 7A of the lid 7 and that the stepped portion 7B is engaged with the upper end corners of the side walls 1A, 1B, 1C, and 1D. In the fifth embodiment, the outside dimension of the lid 7 is smaller than that of the container body 1 in a plan view. As a result, when the stepped portion 7B of the lid 7 is engaged with the upper end corners of the side walls 1A, 1B, 1C, and 1D, the upper end portions of the side walls 1A, 1B, 1C, and 1D on the outside of the rim portion 7A of the lid 7 are exposed. For this reason, a laser beam is applied obliquely from above to the rim portion 7A of the lid 7 and the upper end portions of the side walls 1A, 1B, 1C, and 1D adjacent to the rim portion 7A. The rim portion 7A of the lid 7 is thus welded to the container body 1.

### Sixth Embodiment

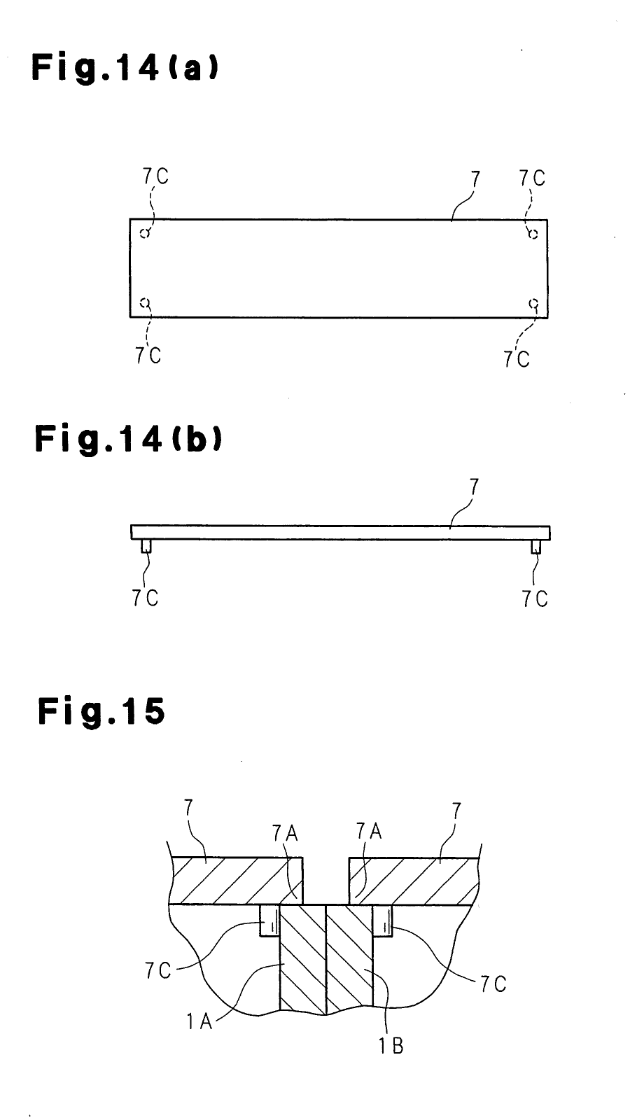

A sixth embodiment of the present invention will hereinafter be described with reference to FIGS. 14(a) to 15. Components in the sixth embodiment identical to those in the first embodiment will not be described in detail.

The sixth embodiment is different from the fifth embodiment in that protrusions 7C are provided on the lower surface of the rim portion 7A of the lid 7 and that the protrusions 7C are engaged with the upper end corners of the side walls 1A, 1B, 1C, and 1D. As shown in FIG. 15, the protrusions 7C are provided at the four respective corners of the container body 1.

1. A molten-salt battery comprising a battery container that houses an electric generation element containing a molten salt,
wherein the battery container includes a container body having an opening at the top thereof and a lid having a rim portion, and
the rim portion of the lid is fitted in the opening and welded to the container body.

2. The molten-salt battery according to claim 1,
wherein the opening of the container body is formed with a stepped portion along the inner peripheral edge of the container body, and
the rim portion of the lid is supported by the stepped portion.

3. The molten-salt battery according to claim 1,
wherein the opening of the container body is formed with a protrusion along the inner peripheral edge of the container body, and
the rim portion of the lid is supported by the protrusion.

4. A molten-salt battery comprising a battery container that houses an electric generation element containing a molten salt,
wherein the battery container includes a container body having an opening at the top thereof and a lid having a rim portion, and
the rim portion of the lid is placed on an opening edge portion of the container body and welded to the container body.

5. The molten-salt battery according to claim 4,
wherein a stepped portion to be engaged with the corner of the opening edge portion of the container body is formed in a lower part of the rim portion of the lid.

6. The molten-salt battery according to claim 4,
wherein a protrusion to be engaged with the corner of the opening edge portion of the container body is formed on the lower surface of the rim portion of the lid.

7. The molten-salt battery according to claim 1,
wherein the electric generation element includes plate-like positive and negative electrodes and a separator arranged between the positive and negative electrodes and containing the molten salt, and
the positive and negative electrodes are arranged in a manner facing each other with the side surfaces thereof being oriented vertically.

8. A molten-salt battery module comprising a plurality of molten-salt batteries according to claim 1,
wherein the molten-salt batteries are arranged and connected laterally with the outer peripheral surfaces of the container bodies of adjacent molten-salt batteries facing each other.

9. The molten-salt battery according to claim 4,
wherein the electric generation element includes plate-like positive and negative electrodes and a separator arranged between the positive and negative electrodes and containing the molten salt, and
the positive and negative electrodes are arranged in a manner facing each other with the side surfaces thereof being oriented vertically.

10. A molten-salt battery module comprising a plurality of molten-salt batteries according to claim 4,
wherein the molten-salt batteries are arranged and connected laterally with the outer peripheral surfaces of the container bodies of adjacent molten-salt batteries facing each other.
